(19) United States
(12) Patent Application Publication
(10) Pub. No.: US 2026/0061944 A1
(43) Pub. Date: Mar. 5, 2026

(54) VEHICLE WITH MOVABLE CONSOLE

(71) Applicant: FCA US LLC, Auburn Hills, MI (US)

(72) Inventors: Mark E Stout, Auburn Hills, MI (US); Stacey L Berger, Auburn Hills, MI (US); Santiago Caceres, Auburn Hills, MI (US); Brandon F Brady, Auburn Hills, MI (US); Travis D Bechtel, Auburn Hills, MI (US)

(21) Appl. No.: 18/821,398

(22) Filed: Aug. 30, 2024

(51) Int. Cl. B60R 11/02; B60N 2/01; B60R 7/04; B60R 11/00

(52) U.S. Cl. CPC B60R 11/02; B60N 2/01; B60R 7/04; B60R 2011/0084; B60R 2011/0092

(57) ABSTRACT

A vehicle includes a vehicle body having a passenger compartment including two seats in a front row, the two seats in the front row being spaced apart in a cross-car direction extending between a left side and a right side of the vehicle, and multiple seats in one or more rows spaced from the front row in a fore-aft direction extending between a front and a rear of the vehicle, and a console. The console is located in the passenger compartment, at least part of the console is a movable portion that is movable from a first position in which the movable portion is received between the two seats in the front row and a second position in which the movable portion is spaced in the fore-aft direction from the two seats in the front row.

### FIELD

The present disclosure relates to a vehicle with a movable console.

### BACKGROUND

Many vehicles include seats arranged in more than one row, with the rows spaced apart within an interior of the vehicle. Conveying items from a passenger in one row of seats to a passenger in another row of seats can be difficult, and may be distractive to vehicle operation if attempted by a driver of the vehicle. In vehicles having three rows of seats, passing items from the front row to a back row can be difficult. Communication between passengers in different rows of seats also can be difficult and distracting. Further, storage within the interior of the vehicle is limited and not secure.

### SUMMARY

In at least some implementations, a vehicle includes a vehicle body having a passenger compartment including two seats in a front row, the two seats in the front row being spaced apart in a cross-car direction extending between a left side and a right side of the vehicle, and multiple seats in one or more rows spaced from the front row in a fore-aft direction extending between a front and a rear of the vehicle, and a console. The console is located in the passenger compartment, at least part of the console is a movable portion that is movable from a first position in which the movable portion is received between the two seats in the front row and a second position in which the movable portion is spaced in the fore-aft direction from the two seats in the front row.

In at least some implementations, a track is located in the passenger compartment and extends in the fore-aft direction, and the movable portion of the console is connected to the track and moves in the fore-aft direction along the track.

In at least some implementations, an actuator is coupled to the movable portion to move the movable portion within the passenger compartment. In at least some implementations, the actuator includes a motor and a drive member driven by the motor and coupled to the movable portion so that the motor causes movement of the movable portion along the track.

In at least some implementations, the drive member includes a belt, chain or cable that extends along at least part of a length of the track, and the drive member is coupled to the movable portion. In at least some implementations, the drive member is a rotating component that engages the track and moves along the track as the rotating component is rotated by the motor.

In at least some implementations, the console includes a first portion that does not move, and the movable portion is adjacent to the first portion when the console is in the first position, and the movable portion is spaced in the fore-aft direction from the first portion when the console is in the second position.

In at least some implementations, the one or more rows includes a second row of seats that has two seats that are spaced apart in the cross-car direction, and the movable portion of the console is movable to a location in which the movable portion overlaps the seats in the second row in the fore-aft direction.

In at least some implementations, the one or more rows includes a third row of seats that has one or more seats spaced in the fore-aft direction from the seats of the second row, and, when the movable portion of the console is in the second position, at least part of the movable portion is located between the second row and the third row.

In at least some implementations, a container is movable along the track, wherein the container is selectively connectable with the movable portion of the console for movement with the movable portion of the console. In at least some implementations, a cargo compartment is separated from the passenger compartment by a divider, and the container is movable from the passenger compartment into the cargo compartment through an opening in the divider. In at least some implementations, the container is movable separately from the movable portion of the console.

In at least some implementations, the movable portion of the console includes one or both of a first video device and a first audio device. In at least some implementations, one or both of a second video device and a second audio device is provided, and the one or both of the second video device and the second audio device are arranged for use by a passenger in the front row.

In at least some implementations, the console includes a display and wherein the second video device is communicated with the display.

In at least some implementations, the first audio device and the second audio device include both an audio input and an audio output to permit two-way audible communication between the first audio device and the second audio device.

In at least some implementations, the movable portion includes a storage compartment in which an item may be placed for movement with the movable portion.

Further areas of applicability of the present disclosure will become apparent from the detailed description, claims and drawings provided hereinafter. It should be understood that the summary and detailed description, including the disclosed embodiments and drawings, are merely exemplary in nature intended for purposes of illustration only and are not intended to limit the scope of the invention, its application or use. Thus, variations that do not depart from the gist of the disclosure are intended to be within the scope of the invention.

### BRIEF DESCRIPTION OF THE DRAWINGS

FIG. 1 is a perspective view of a vehicle;

FIG. 2 is an overhead view of part of the vehicle showing one or more storage containers in a cargo compartment;

FIG. 3 is a side view of part of the vehicle as in FIG. 2;

FIG. 4 is an overhead view of part of the vehicle showing one or more storage containers in a passenger compartment;

FIG. 5 is a side view of part of the vehicle as in FIG. 4;

FIG. 6 is an overhead view of part of the vehicle showing a console in a second position within the passenger compartment;

FIG. 7 is a side view of the part of the vehicle as in FIG. 6; and

FIG. 8 is an overhead view of part of the vehicle showing the console in a third position within the passenger compartment.

### DETAILED DESCRIPTION

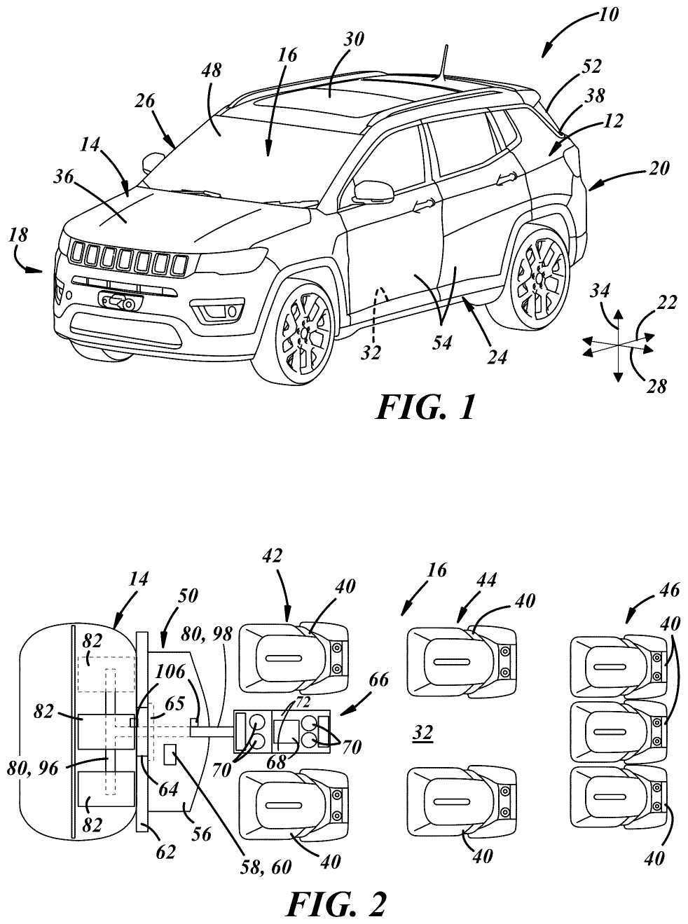

Referring in more detail to the drawings, FIG. 1 shows a vehicle 10 that includes a vehicle body 12 having a cargo compartment 14 and a passenger compartment 16. The vehicle includes one or both of a movable storage container and a movable console that provide flexible storage options usable by more occupants of the vehicle and enabling greater storage space and access to the storage space.

The vehicle 10 includes a front end 18 and a rear end 20 that are spaced apart in a fore-aft direction (shown by arrow 22), left and right sides 24, 26 that are spaced apart in a cross-car direction (shown by arrow 28), and a roof 30 and floor 32 that are spaced apart in a vertical direction (shown by arrow 34). The cargo compartment 14 may be separate from the passenger compartment 16 and typically is provided at one or both of the rear of the vehicle 10 (often called a trunk) and the front of the vehicle 10 (often called a front compartment 14 or frunk). A vehicle deck lid, such as a hood 36 or trunk lid/tailgaite 38 may define part of the cargo compartment 14 which may be separate from or contiguous/open to the passenger compartment 16, in at least some implementations. The deck lid is movable from a closed position to an open position to permit access to the area beneath the deck lid, which may include the cargo compartment 14. While not limited to electric vehicles, certain electric vehicles have considerable space available in the front compartment 14 or frunk and may be readily adapted for storage as noted herein.

Referring to FIGS. 2-5, the passenger compartment 16 is part or all of a vehicle interior and includes seats 40 for vehicle 10 occupants. In the example shown, a front row 42 of seats 40 includes two seats, e.g. for a driver and front passenger, a second row 44 with two seats 40 spaced apart in the cross-car direction, and a third row 46 having three seats 40. Any desired seating configuration may be used. The passenger compartment 16 may be defined at least in part by the roof 30 (e.g. interior headliner), floor 32, a windshield 48 (FIG. 1) and an instrument panel 50 at a front of the passenger compartment 16, a rear window 52 (FIG. 1) and/or body panel at a rear of the passenger compartment 16, and one or more doors 54 (FIG. 1) at the left and right sides 24, 26 of the vehicle 10, and associated vehicle structural components, such as pillars that extend to and are coupled to the roof.

The instrument panel 50 includes one or more interior trim pieces 56 and one or more displays 58 on which vehicle operational information is provided (e.g. gauges for speed, engine temperature and engine rpms, and icons for warning messages, etc.) and via which a human-machine interface (HMI) 60 may be provided. The HMI 60 may be part of an infotainment system by which various vehicle controls may be implemented or selected by a user, such as by a touch screen or other inputs like buttons or dials, and by which a remote device may be connected (e.g. a smart phone) and audio (e.g. radio/sound system) and other devices or systems may be accessed for user control. On or near the instrument panel 50, one or more drive controls may be provided, such as a steering input/wheel, a transmission/powertrain gear selector, an accelerator input and a brake input. The instrument panel 50 may define or be connected to a divider 62 that spans in the cross-car direction between the left and right sides 24, 26, in the vertical direction from the floor 32 to the windshield 48, and is located in the fore-aft direction between the cargo compartment 14 and the passenger compartment 16. The divider 62 may be, in at least some implementations, a structural member of the vehicle 10, sometimes called a firewall and may be used to separate powertrain components in the front compartment 14 from the passenger compartment 16 and to mount or passthrough various vehicle 10 components within the front compartment 14. The divider 62 may define at least part of the passenger compartment 16, in at least some implementations.

To permit at least selective communication between the cargo compartment 14 and the passenger compartment 16, an opening 64 is provided in the divider 62. The opening 64 may be located below the instrument panel 50 or through part of the instrument panel 50. In at least some implementations, a cover 65 is provided that is movable relative to the opening 64 to selectively close and open the opening 64.

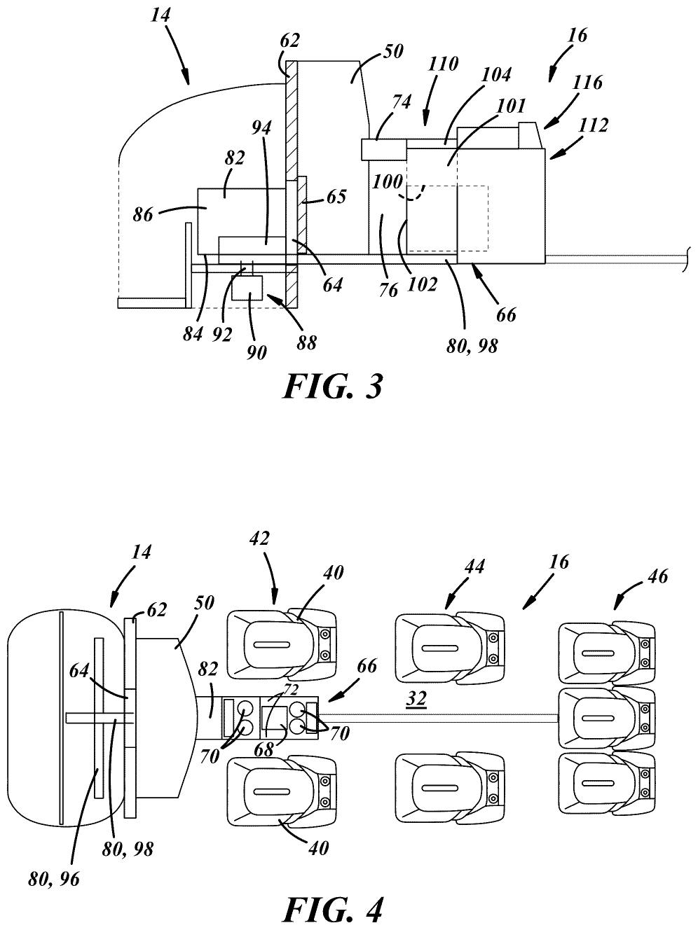

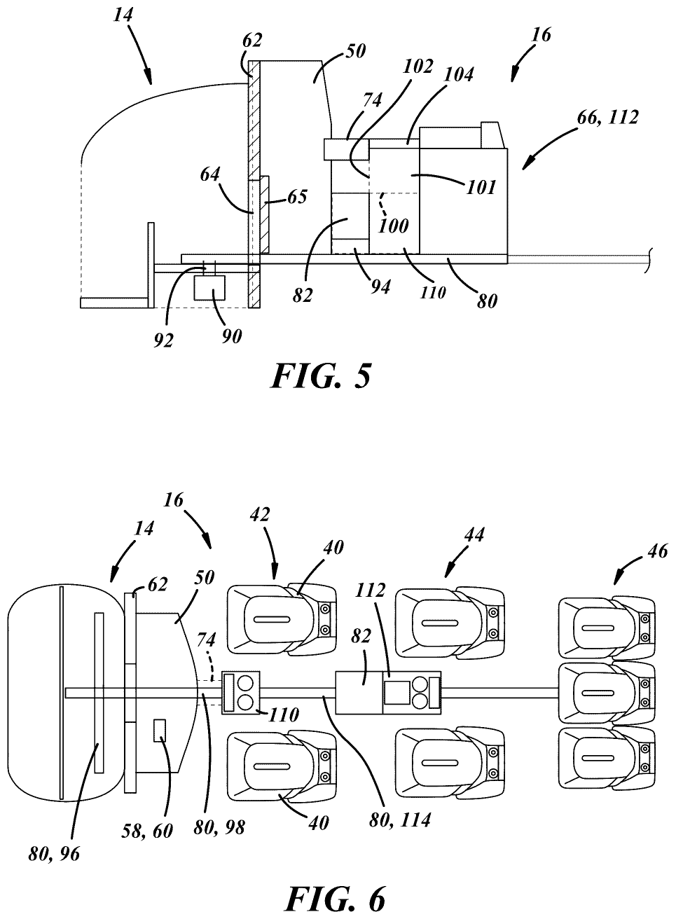

The vehicle 10 may include a console 66 that may, for example, have one or more storage compartments 68, one or more cupholders 70, an armrest 72 and other features or components as desired. The console 66 may be located between two seats 40, such as between the front two seats, as shown in FIGS. 2-5. In this arrangement, the console 66 may be generally centered in the cross-car direction and may be spaced from the instrument panel 50 in the fore-aft direction. The console 66 could be part of the instrument panel 50, or it may be coupled thereto by a bridge 74, such as is shown in FIGS. 3 and 5. The bridge 74 may provide some of the features noted (e.g. cupholders or storage areas) and may be spaced vertically from the floor 40 and arranged near an upper portion of the console 66. A space 76 (FIG. 3) may be provided between a lower surface of the bridge 74 and the floor 40, and things may be stowed in the space. Sidewalls or the like may be provided to contain items and keep the items out of footwells in front of the seats 40.

To contain stowed items and to facilitate moving items between the cargo compartment 14 and the passenger compartment 16, the vehicle 10 may include a container path 79 that extends through the opening and between the cargo compartment 14 and at least partly into the passenger compartment 14. A track 80 may be provided along at least part of the path 79, and the track 80 may extend through the opening 64 and has part located in the cargo compartment 14 and/or part in the passenger compartment 16. The track 80 may be of any suitable construction and may be continuous or discontinuous along its length which may be oriented in the fore-aft direction. The track 80 may extend into the passenger compartment 16 and to, partly into or adjacent to the console 66. While shown as an elongated and generally flat member received on the floor of the vehicle 10, the track 80 may instead or in addition include sidewalls or guiderails spaced apart in the cross-car direction.

To facilitate transferring things between the cargo compartment 14 and the passenger compartment 16, a container 82 is associated with the track 80 and is movable along the track 80. As shown in FIG. 3, the container 82 has a body which may include a bottom wall 84 and sidewalls 86 extending vertically from the bottom wall 84. The container 82 may be open at its upper end or closed, such as by a removable or movable cover or lid. Items may be placed in and contained by the container 82, and removed thereform, as desired. As shown in FIGS. 2 and 3, the container 82 has a first position in which the container 82 is located within the cargo compartment 14 and, as shown in FIGS. 4 and 5, a second position in which the container 82 is located within the passenger compartment 16. The container 82 may be of any suitable size and shape and is designed to pass through the opening 64 when it moves between the first and second positions, and the container 82 may be stopped between those positions in one or more intermediate positions, as desired.

The container 82 may be manually moved along the track 80 or the container 82 may be coupled to and driven by an actuator 88. In at least some implementations, the actuator 88 includes a motor 90 and a drive member 92 that is driven by the motor. For example, the motor 90 may be fixed in the vehicle 10, such as in the cargo compartment 14 or otherwise in the front compartment 14, and the motor 90 the drive member 92 may be a power transmission member, such as a belt, chain or cable. The belt, chain or cable may be driven by a gear or wheel that is rotated by the motor 90, or otherwise driven, as desired. To move the container 82, the container 82 may be coupled to the drive member 92 for movement as the drive member 92 moves. In at least some implementations, as shown in FIGS. 3 and 5, a shuttle or carrier 94 is provided that is coupled to the drive member 92, and the container 82 is connected to the carrier 94 so that both the carrier 94 and container 82 are driven by the motor 90. Other arrangements may be used, as desired. For example, the motor 90 may be carried by the container 82 and may directly rotate wheels coupled to the container 82 to move the container 82 relative to the vehicle 10. The wheels may move along the vehicle floor, or along the track 80, or both.

In at least some implementations, the container 82 may be movable within the cargo compartment 14 such that the container 82 has positions in which the container 82 is not aligned with the opening 64. That is, the container 82 may be offset in the cross-car direction, for example, from the opening 64. To facilitate such movement, as shown in FIGS. 2 and 4, the track 80 may include a second portion 96 that is received in the cargo compartment 14 and which guides and enables movement of the container 82 in the cross-car direction. In the example shown, the second portion 96 is provided at an end of the first portion 98, which extends into the passenger compartment 16. This lateral or cross-car movement of the container 82 can help to move the container 82 out of the center of the cargo compartment 14.

Additionally, the movement in a second direction enables more than one container 82 to be received in the cargo compartment 14, and selectively aligned with and movable through the opening 64, as shown in FIG. 2. In this way, a first container 82 may be moved in the cross-car direction out of the way of the opening 64 and spaced from the end of the first portion 98 of the track 80, to permit a second container 82 to be aligned with the opening 64 and ready for movement along the first portion 98 of the track 80 (e.g. into the passenger compartment 16). The second portion 96 of the track 80 may accommodate movement of a container 82 in one or both directions away from the opening 64 (e.g. toward the right and/or left sides of the vehicle 10). A separate actuator may be provided to move the containers 82 in the cross-car direction. The containers 82 may be moved along the second portion 96 on a carrier or shuttle 94, which may be arranged for movement along both the second portion 96 and the first portion 98 of the track 80, in a least some implementations. In this way, each container 82 may be received on a separate carrier or shuttle 94. The containers 82 may be releasable from the carriers or shuttles 94 and track 80 to permit the containers 82 to be removed from the vehicle 10, if desired.

To facilitate loading the containers 82 from within the passenger compartment 16 or retrieving items from the containers 82 from within the passenger compartment 16, in at least some implementations, the container 82 meshes or cooperates with the console 66. In the embodiment shown, and with reference to FIGS. 3 and 5, the console 66 includes a void 100 in a forward most or forward-facing side 102 of the console 66. When the container 82 is in the second position, the container 82 is received at least partially in the void 100. The container 82 may define part or all of a storage compartment of the console 66, and it may be accessed by opening a lid or cover 104 on the console 66 that overlies a console opening 101 or chamber leading to the void 100.

In at least some embodiments, the container 82 may be moved to the second position while the vehicle 10 is in use, to permit items to be stored in and retrieved from the console 66. This may occur automatically, if desired, when the vehicle 10 is turned on or otherwise set for use. Additionally, when the vehicle 10 is turned off or otherwise set for non-use, the container 82 may be moved into the cargo compartment 14 so that the container 82 and the contents therein are not accessible from within the passenger compartment 16. This may also be done automatically, if desired. Or this may be done as commanded by a user (e.g. via the HMI). This may be desirable to deter thieves from breaking into the passenger compartment 16 in search of items left in the passenger compartment 16.

In this regard, the cover 65 for the opening 64 may be closed other than when the container 82 is moving therethrough. The cover 65 may be opened manually, or automatically by an actuator. Proximity switches or sensors 106 (FIG. 2), for example, may be used to control movement of the cover 65 to permit a container 82 to pass through the opening 64 and to close the opening 64 after a container 82 moves through the opening 64. The cover 65 could be mechanically driven by movement of the container 82 relative thereto, if desired. By way of a non-limiting example, the container 82 may as it moves near the cover 65 displace a lever or cam that causes movement of the cover 65, and the system may be spring loaded to return to a starting position after such movement. Of course, other arrangements may be used, as desired. This may desirable for security reasons as well as for noise and environment isolation from the passenger compartment 16.

Further, the cargo compartment 14 may be fully enclosed or lockable such that opening the deck lid does not provide direct access to the cargo compartment 14 and containers 82. In this way, items may be stored securely when the vehicle 10 is not in use, or if the vehicle 10 is to be used by another person, for example without limitation, a valet who may drive the car to park it. Prior to giving the vehicle 10 to the valet (or other person), the container 82 may be moved into the cargo compartment 14. Further, the system can be set up to prevent others from commanding the container(s) 82 to move out of the cargo compartment 14, for example, by a lock/key or password/secure identification (e.g. fingerprint reader) type arrangement.

In addition to or instead of having a storage container 82 that is movable between the cargo compartment 14 and the passenger compartment 16, at least part of the console 66 may be movable within the passenger compartment 16, as generally shown in FIGS. 6-8. In the example shown, the console 66 includes a first portion 110 that may be fixed and not movable, and a second portion 112 that is movable relative to the first portion 110.

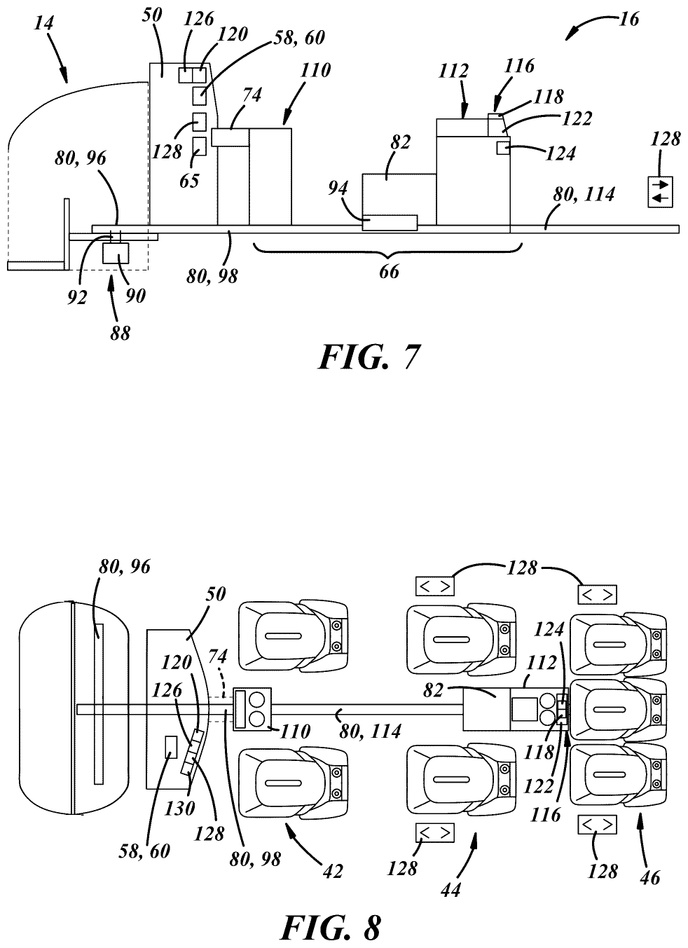

In at least some implementations, the void 100 in the console 66 is a passage through the first portion 110 of the console 66. The container 82 can then pass through the first portion 110 of the console 66, and can be connected to or otherwise movable with the second portion 112 of the console 66. Even without the container 82, the console 66, such as the second portion 112 thereof, can move relative to the front row of seats, in the fore-aft direction. In this way, the container 82 may be selectively coupled to the console 66, such as by an electromechanical latch, movable hook or the like. As shown in FIGS. 6 and 7, the console 66, with or without the container 82, can move to or toward the second row 44 of seats 40 for use of the console 66 by occupants in the second row 44. At least part of the second portion 112 of the console 66 may be overlapped, in the fore-aft direction, with the seats 40 in the second row 44. As shown in FIG. 8, in at least some implementations, the console 66 can move to a position in front of the third row 46 of seats 40, again, with or without the container 82. In this position, some or all of the second portion 112 of the console 66 may be located between the second row 44 and third row 46 of seats, in the fore-aft direction.

In the example shown, the track 80 includes a third portion 114 that extends beyond the console 66 in the fore-aft direction, and between the second row 44 of seats and to or toward the third row 46 of seats. The third portion 114 may be an extension of and contiguous with the first portion 98 of the track 80, if desired. In this way, the drive member 92 of the actuator 88, at least when an elongated member such as a belt, rotatable or stationary screw (e.g. along which the shuttle travels without rotation about the screw), chain or cable, can extend along at least part of the third portion 114 of the track 80. The second portion 112 of the console 66 can be selectively connectable to the drive member 92 and moved along the track 80 when so connected and when the drive member 92 is driven by the motor 90. In other implementations, a motor may be associated with the second portion 112 of the console 66, and may drive rotary components, like wheels, sprockets (e.g. with projections that engage spaced holes in the track) or the like, to move the console 66 along the third portion 114 of the track 80.

The movable console 66/112 permits many functions. For example, a person in one row of seats can place items on the console 66 for delivery to a person in another row. The console 66 can provide cupholders 70 and storage bins 68 within reach of passengers in the various rows 42, 44, 46 of seats 40. Further, if the console 66 includes a HMI 116, for example, to control in-vehicle displays, movies, gaming or the like), heating and cooling (e.g. for rows other than the front row of seats) or audio equipment, moving the console 66 can permit passengers in different rows to have access to such HMI controls 116. Further, if the container 82 moves with the console 66, then passengers in the second or third row 44 or 46 of seats can have access to the container 82 and can take items out of or place items in the container 82 for delivery to a passenger in a different row of seats, or into the cargo compartment 14, if a container 82 is also available. To facilitate passenger ingress and egress from the vehicle 10, the second portion 112 of the console 66 can be moved to its first position, adjacent to the front row 42 of seats, as desired.

In at least some implementations, as shown in FIGS. 7 and 8, a video output device 118, e.g. a camera, may be provided on the movable console 66 and the camera 118 may provide a video feed to a display 58 on the instrument panel 50, for example. This may enable a person in the front row 42 of seats to see at least part of the passenger compartment 16 that is behind them, without having to turn around. In one example, the camera field of view may include the seats 40 in the second row 44 and/or third row 46, and in particular, a child's seat, to enable a driver or other front row passenger to monitor a child in that seat. For two-way viewing, another video device/camera 120 may be provided with a field of view including the front row 42 of seats, and in particular, a driver's seat. The console 66 may include a display 122 and one or both cameras 118, 120 may provide a video feed to the display 122 (as well as to the instrument panel display 58 or other display in the vehicle). Audio devices 124, 126 may have inputs and outputs (e.g. microphones and speakers) and may also or instead of the cameras be provided at both of the console 66 and instrument panel 50 (or other location accessible by front row passenger(s)) to facilitate two-way audible communication between passengers in different rows of seats. In this way, the movable console 66 may include video and/or audio devices that enable a video and/or audio interface with passengers in different rows of seats.

Suitable controls 128 to cause movement of the console 66 (e.g. forward and backward buttons or inputs) may be provided in one or more desired locations within the passenger compartment 16. The controls 128 may provided near the front row 42 of seats, for example on the instrument panel 50, or on the first portion 110 of the console 66, to enable control of the location of the console 66 by a passenger in the front row 42 of seats. Additional controls 128 may be provided near the seats in the other rows 44, 46 of seats, if desired, so passengers in those seats can command movement of the console 66. In such implementations, it may be desirable to have an override switch 130 located for access by passengers in the front row 42 of seats so that a passenger in the front row can prevent passengers in the second or third rows 44, 46 from moving the console 66 when such movement is not desired.

In addition to user commanded motion of the console 66, some movement of the console 66 may occur automatically, if desired. For example, when the console 66 is not in the first position, the system may actuate the motor to return the console 66 to the first position, for example, when the vehicle is powered off. This may move the console 66 out of an aisle between the second and/or third row 44, 46 of seats, and facilitate passenger ingress and egress from the vehicle 10.

The systems provide a unique storage solution that enables easy transfer of things between a passenger compartment 16 and a cargo/storage compartment 14, and/or transfer of things between passengers in different rows of the vehicle. This may facilitate having more things accessible within the vehicle, such as with multiple containers that may be selectively brought into the passenger compartment 16 from the cargo compartment. Increased security is also achievable by enabling stored items to be removed from the passenger compartment 16 and located in a secure area outside of the passenger compartment 16 when not needed, or when the vehicle is parked or might be driven by another person. In at least some implementations, the console 66 may be used to store items that are more frequently used or needed in use of the vehicle, and the cargo compartment may be used to store items less frequently needed or used, and to securely store things when the vehicle is not in use, or is in a valet or similar mode. Further, the movable console 66 can include video and/or audio devices to facilitate communication by passengers in different rows within the passenger compartment 16.

What is claimed is:

1. A vehicle, comprising:
a vehicle body having a passenger compartment including two seats in a front row, the two seats in the front row being spaced apart in a cross-car direction extending between a left side and a right side of the vehicle, and multiple seats in one or more rows spaced from the front row in a fore-aft direction extending between a front and a rear of the vehicle; and
a console located in the passenger compartment, at least part of the console being a movable portion that is movable from a first position in which the movable portion is received between the two seats in the front row and a second position in which the movable portion is spaced in the fore-aft direction from the two seats in the front row.

2. The vehicle of claim 1 which also includes a track located in the passenger compartment and extending in the fore-aft direction, and wherein the movable portion of the console is connected to the track and moves in the fore-aft direction along the track.

3. The vehicle of claim 1 which also includes an actuator coupled to the movable portion to move the movable portion within the passenger compartment.

4. The vehicle of claim 3 wherein the actuator includes a motor and a drive member driven by the motor and coupled to the movable portion so that the motor causes movement of the movable portion along the track.

5. The vehicle of claim 4 wherein the drive member includes a belt, chain or cable that extends along at least part of a length of the track, and the drive member is coupled to the movable portion.

6. The vehicle of claim 4 wherein the drive member is a rotating component that engages the track and moves along the track as the rotating component is rotated by the motor.

7. The vehicle of claim 1 wherein the console includes a first portion that does not move, and wherein the movable portion is adjacent to the first portion when the console is in the first position, and the movable portion is spaced in the fore-aft direction from the first portion when the console is in the second position.

8. The vehicle of claim 1 wherein the one or more rows includes a second row of seats that has two seats that are spaced apart in the cross-car direction, and wherein the movable portion of the console is movable to a location in which the movable portion overlaps the seats in the second row in the fore-aft direction.

9. The vehicle of claim 8 wherein the one or more rows includes a third row of seats that has one or more seats spaced in the fore-aft direction from the seats of the second row, and wherein, when the movable portion of the console is in the second position, at least part of the movable portion is located between the second row and the third row.

10. The vehicle of claim 2 which also includes a container movable along the track, wherein the container is selectively connectable with the movable portion of the console for movement with the movable portion of the console.

11. The vehicle of claim 10 which also includes a cargo compartment separated from the passenger compartment by a divider, and wherein the container is movable from the passenger compartment into the cargo compartment through an opening in the divider.

12. The vehicle of claim 11 wherein the container is movable separately from the movable portion of the console.

13. The vehicle of claim 1 wherein the movable portion of the console includes one or both of a first video device and a first audio device.

14. The vehicle of claim 13 which includes one or both of a second video device and a second audio device, wherein the one or both of the second video device and the second audio device are arranged for use by a passenger in the front row.

15. The vehicle of claim 14 wherein the console includes a display and wherein the second video device is communicated with the display.

16. The vehicle of claim 14 wherein the first audio device and the second audio device include both an audio input and an audio output to permit two-way audible communication between the first audio device and the second audio device.

17. The vehicle of claim 1 wherein the movable portion includes a storage compartment in which an item may be placed for movement with the movable portion.
